(19) United States
(12) Patent Application Publication
(10) Pub. No.: US 2014/0241591 A1
(43) Pub. Date: Aug. 28, 2014

(54) INFORMATION OBTAINING DEVICE, DISPLAY CONTROL SYSTEM, AND BIOMETRIC AUTHENTICATION SYSTEM

(71) Applicant: PANASONIC CORPORATION, Osaka (JP)

(72) Inventor: Daizaburo MATSUKI, Osaka (JP)

(73) Assignee: PANASONIC CORPORATION, Osaka (JP)

(21) Appl. No.: 14/189,744

(22) Filed: Feb. 25, 2014

(30) Foreign Application Priority Data
Feb. 27, 2013 (JP) 2013-036570
Jan. 23, 2014 (JP) 2014-010647

(51) Int. Cl. G06K 9/00; G06K 9/20

(52) U.S. Cl. CPC G06K 9/00885; G06K 9/20
USPC 382/115

(57) ABSTRACT

An information obtaining device includes: an obtaining section configured to obtain biological information of a user and an information pattern formed in a display panel or on a paper surface; a collation section configured to collate the biological information of the user obtained by the obtaining section with pre-registered biological information; an authentication section configured to authenticate the user on the basis of a collation result of the collation section; and a control section configured to control whether to start a process of reading the information pattern, on the basis of an authentication result of the authentication section, the process including a process of obtaining the information pattern by the obtaining section.

### BACKGROUND

1. Field

The present disclosure relates to an information obtaining device, a display control system, and a biometric authentication system which are able to authenticate a user by biometric authentication.

2. Description of the Related Art

Hitherto, a technology is known in which biometric authentication is performed by using a sensor for biometric authentication in an electronic pen which obtains a pattern of dots or the like arranged on a paper surface

Such a technology is described in Japanese Laid-Open Patent Publication No. 2011-18127.

### SUMMARY

In the conventional technology described in Japanese Laid-Open Patent Publication No. 2011-18127, different components are used in an imaging system for obtaining a pattern of dots or the like and an imaging system for biometric authentication. Thus, the number of components is increased.

The present disclosure provides an information obtaining device that is effective for reducing the number of components in an information obtaining device capable of biometric authentication.

An information obtaining device according to the present disclosure is an information obtaining device which obtains an information pattern formed in a display panel or on a paper surface. The information obtaining device includes: an obtaining section configured to obtain the information pattern and biological information of a user; a collation section configured to collate the biological information of the user obtained by the obtaining section with pre-registered biological information; an authentication section configured to authenticate the user on the basis of a collation result of the collation section; and a control section configured to control whether to start a process of reading the information pattern, on the basis of an authentication result of the authentication section, the process including a process of obtaining the information pattern by the obtaining section.

The information obtaining device according to the present disclosure is effective for reducing the number of components in an information obtaining device capable of biometric authentication.

### BRIEF DESCRIPTION OF THE DRAWINGS

FIG. 1 is a schematic diagram showing a situation where a user uses a display control system 100;

FIG. 2 is a block diagram of the display control system 100;

(a) of FIG. 3 is a cross-sectional view of a digital pen 10 when an information pattern 3 is obtained, and (b) of FIG. 3 is a cross-sectional view of the digital pen 10 when biometric authentication is performed using a finger vein pattern of a user;

(a) of FIG. 4 is a diagram showing an arrangement pattern of marks 31, and (b) of FIG. 4 is a schematic diagram for explaining the information pattern 3;

FIG. 5 is a schematic diagram for explaining that information obtained by numeric conversion of the position of the mark 31 is different depending on the position of the mark 31;

(a) of FIG. 6 is a flowchart showing flow of a process regarding the digital pen 10, and (b) of FIG. 6 is a flowchart showing flow of a process of biometric authentication;

FIG. 7 is a flowchart showing flow of a process regarding a digital pen 10 according to a modification of the embodiment;

(a) of FIG. 8 is a cross-sectional view of a digital pen, and (b) of FIG. 8 is a cross-sectional view of the digital pen (a cross-sectional view taken in a direction different from that in (a));

(a) of FIG. 9 is a cross-sectional view of a digital pen when biometric authentication is not performed, and (b) of FIG. 9 is a cross-sectional view of the digital pen when biometric authentication is performed; and

FIG. 10 is a schematic diagram showing a biometric authentication system.

### DETAILED DESCRIPTION

Hereinafter, embodiments will be described in detail with reference to the drawings as appropriate. However, there will be instances in which detailed description beyond what is necessary is omitted. For example, detailed description of subject matter that is previously well-known, as well as redundant description of components that are substantially the same will in some cases be omitted. This is to prevent the following description from being unnecessarily lengthy, in order to facilitate understanding by a person of ordinary skill in the art.

The applicant provides the following description and the accompanying drawings in order to allow a person of ordinary skill in the art to sufficiently understand the present disclosure, and the description and the drawings are not intended to restrict the subject matter of the scope of the patent claims.

### Embodiment 1

[1. Outline of Display Control System]

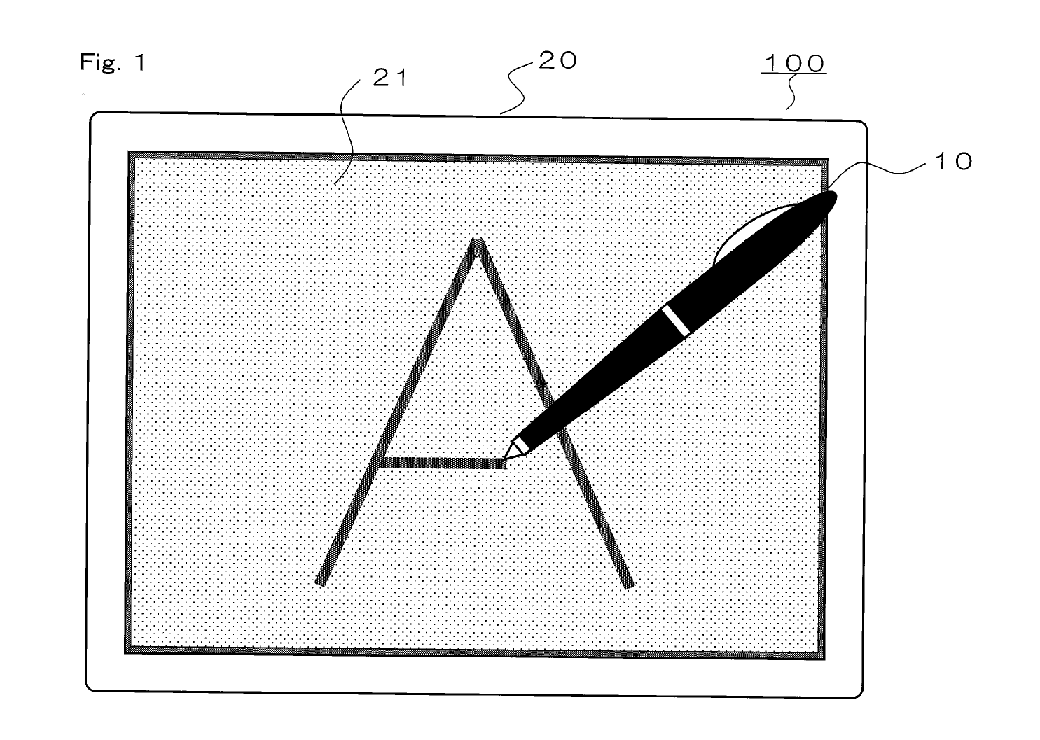

FIG. 1 is a schematic diagram showing the appearance of a display control system 100 according to Embodiment 1. The display control system 100 includes an optical digital pen (hereinafter, referred to merely as “digital pen”) 10 and a display device 20. The digital pen 10 is an example of an information obtaining device (e.g., a reading device).

Although described in detail later, the display device 20 is a liquid crystal display capable of displaying various images on a display panel 21 (a display section). In addition, the display device 20 is provided with information patterns 3 (position information patterns) each representing information regarding a position on a display surface of the display panel 21. In the display panel 21, a plurality of the information patterns 3 are formed, for example, on an optical filter (not shown) laminated on a liquid crystal display section. The digital pen 10 detects information regarding a position of the tip of the digital pen 10 on the display surface of the display panel 21 (hereinafter, also referred to as “position information”) by optically reading an information pattern 3, and transmits the position information to the display device 20. The display device 20 receives the position information as an input and performs various display control. It should be noted that the reading of the information pattern 3 means to obtain the information pattern 3 and recognize the obtained information pattern 3 as information.

For example, when the tip of the digital pen 10 is moved on the display surface of the display panel 21, the digital pen 10 detects continuous position information as a trajectory of the tip of the digital pen 10 from continuously read information patterns 3. The display device 20 continuously displays spots on the display panel 21 in accordance with the trajectory of the tip of the digital pen 10. By so doing, it is possible to perform a handwriting input of a character, a figure, or the like on the display panel 21 by using the digital pen 10. Or the display device 20 continuously deletes spots displayed on the display panel 21, in accordance with the trajectory of the digital pen 10. By so doing, it is possible to delete a character or a figure on the display panel 21 by using the digital pen 10 like an eraser. In other words, the digital pen 10 serves as a reading device and also serves as an input device that performs an input to the display control system 100.

[2. Configuration of Display Device]

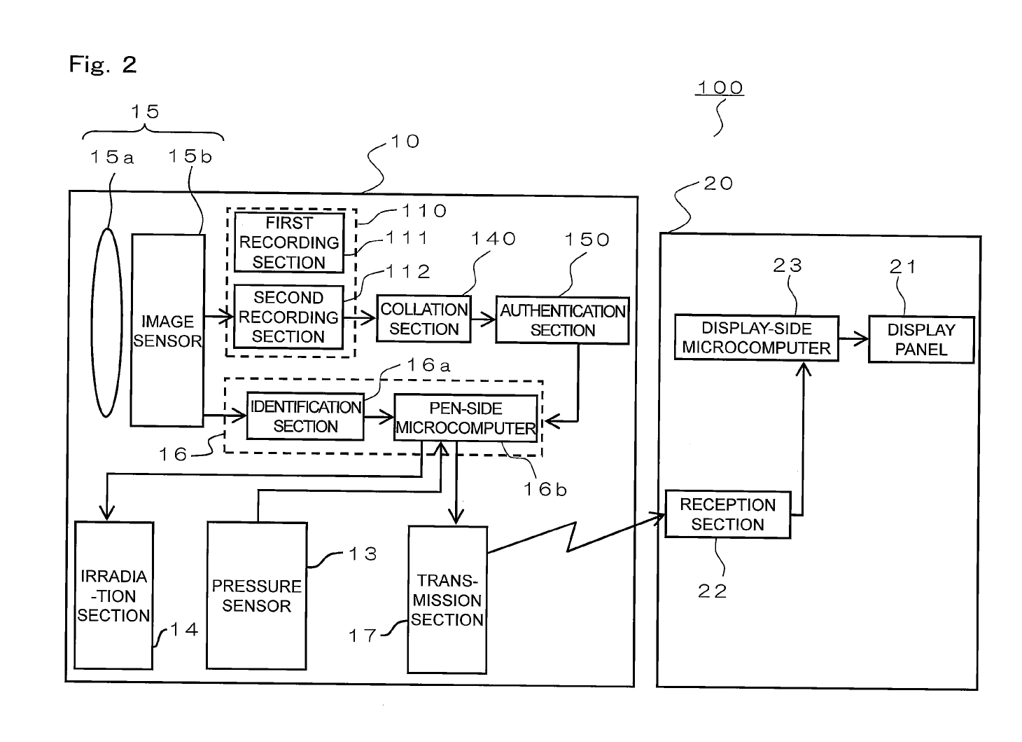

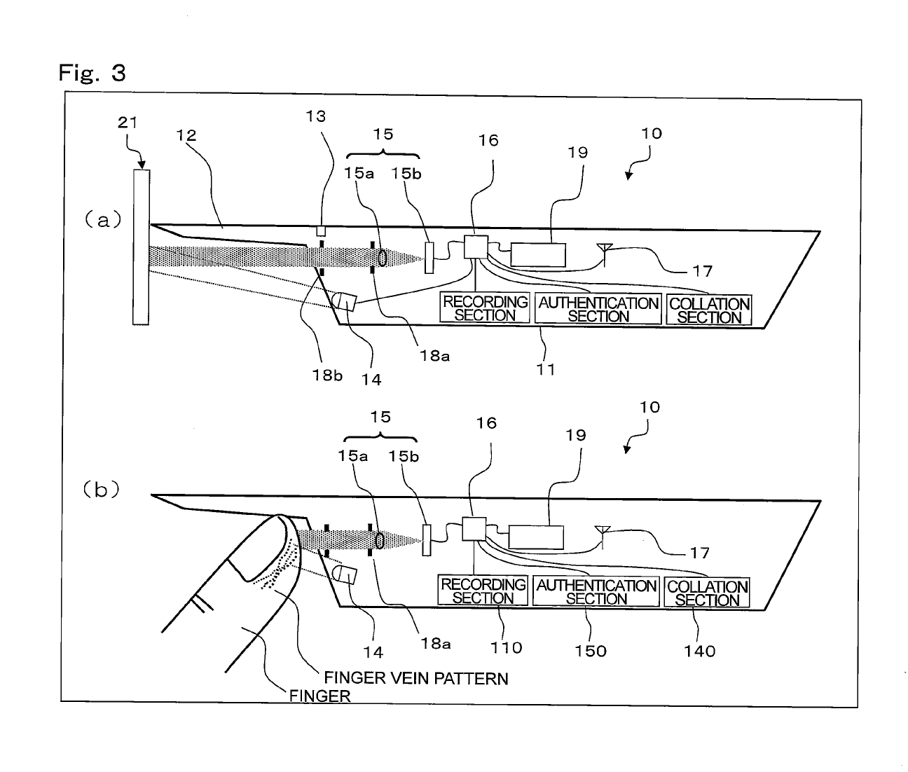

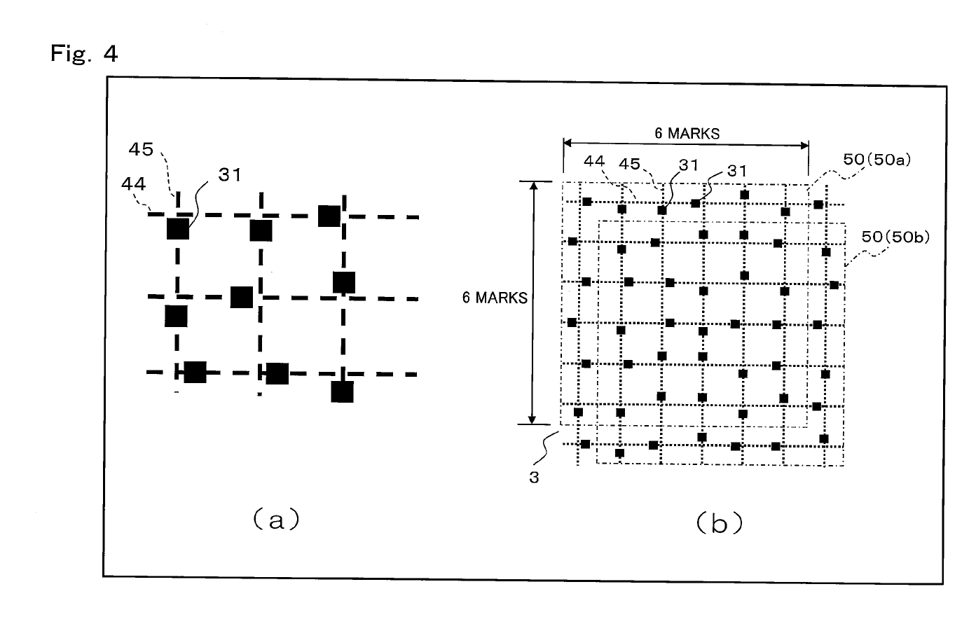

Hereinafter, the display device 20 will be described. FIG. 2 is a block diagram showing a schematic configuration of the display control system 100.

The display device 20 includes a reception section 22 that receives a signal from an external device, a display-side microcomputer 23 that controls the entirety of the display device 20, and the display panel 21 that displays an image.

The reception section 22 receives a signal transmitted from the digital pen 10 described in detail later. The signal received by the reception section 22 is transmitted to the display-side microcomputer 23.

The display-side microcomputer 23 is composed of a CPU, a memory, and the like. The display-side microcomputer 23 is provided with a program for causing the CPU to operate. For example, the display-side microcomputer 23 controls the display panel 21 on the basis of a signal transmitted from the digital pen 10 and changes a content displayed on the display panel 21.

[3. Configuration of Digital Pen]

Next, a detailed configuration of the digital pen 10 will be described with reference to FIGS. 2 and 3.

FIG. 3 is a cross-sectional view showing a schematic configuration of the digital pen 10, (a) of FIG. 3 shows the case where an information pattern 3 is obtained, and (b) of FIG. 3 shows the case where biometric authentication is performed by using a finger vein pattern of a user.

As shown in FIG. 2, the digital pen 10 includes a pressure sensor 13, an irradiation section 14, an obtaining section 15, a control section 16, a transmission section 17, a recording section 110, a collation section 140, and an authentication section 150.

The recording section 110 includes a first recording section 111 that temporarily stores biological information (hereinafter, also referred to as “obtained biological information”) of the user which is obtained through image capturing by the digital pen 10; and a second recording section 112 that has previously stored therein user information and biological information (hereinafter, also referred to as “registered biological information”) of the user which are information pre-registered by the user or the like and are used for identifying the user. In the second recording section 112, the registered biological information is associated with the user information. The user information for identifying the user includes, for example, the name, age, and gender of the user. The biological information of the user is, for example, a finger vein pattern of the user. It should be noted that in the case of performing fingerprint authentication as biometric authentication, a fingerprint pattern of the user is stored as registered biological information in the second recording section 112. In addition, in the case of performing iris authentication as biometric authentication, an iris pattern of the user is stored as registered biological information in the second recording section 112.

The collation section 140 has a function of collating the obtained biological information stored in the first recording section 111 with the registered biological information stored in the second recording section 112 and outputting the collation result to the authentication section 150. As a collation process, the collation section 140 determines whether the obtained biological information matches with the registered biological information, and outputs the determination result as a collation result.

The authentication section 150 has a function of determining whether to authenticate the user, in accordance with the collation result received from the collation section 140. When receiving a collation result that the obtained biological information matches with the registered biological information, the authentication section 150 performs an authentication process of authenticating the user.

Next, a process of reading an information pattern 3 with the digital pen 10 (a reading process) will be described with reference to (a) of FIG. 3.

As shown in FIG. 3, the digital pen 10 includes a cylindrical body case 11, a pen tip portion 12 that is attached to a tip end of the body case 11, the pressure sensor 13 that detects a pressure applied to the pen tip portion 12, the irradiation section 14 that emits infrared light, the obtaining section 15 that obtains information (an image) of an information pattern 3 from infrared light incident thereon, the control section 16 that controls the digital pen 10, the transmission section 17 that outputs a signal to an external device, and a power supply 19 that supplies power to each component of the digital pen 10. It should be noted that in FIG. 3, the digital pen 10 includes diaphragms 18a and 18b.

The body case 11 has an outer shape similar to that of a general pen and is formed in a cylindrical shape. The pen tip portion 12 is formed in a tapered shape. The tip of the pen tip portion 12 is slightly rounded such that the tip does not damage the surface of the display panel 21. In addition, the pen tip portion 12 preferably has such a shape that the user is allowed to easily recognize an image displayed on the display panel 21.

The pressure sensor 13 is provided within the body case 11 and is connected to a base portion of the pen tip portion 12. The pressure sensor 13 detects a pressure applied to the pen tip portion 12 and transmits the detection result to the control section 16. Specifically, the pressure sensor 13 detects a pressure applied from the display panel 21 to the pen tip portion 12 when the user writes a character or the like on the display panel 21 with the digital pen 10. In other words, the pressure sensor 13 is used when it is determined whether the user intends to perform an input with the digital pen 10.

The irradiation section 14 is provided in a tip end portion of the body case 11 and near the pen tip portion 12. The irradiation section 14 includes, for example, one or a plurality of infrared LEDs (light sources). The irradiation section 14 is configured to emit infrared light from the tip end of the body case 11.

The obtaining section 15 is provided in the tip end portion of the body case 11 and near the pen tip portion 12. The obtaining section 15 includes an objective lens 15a and an image sensor 15b. The objective lens 15a causes light, incident thereon from the pen tip side, to form an image on the image sensor 15b. The objective lens 15a is provided in the tip end portion of the body case 11. Here, when infrared light is emitted from the irradiation section 14 in a state where the tip of the digital pen 10 is directed to the display surface of the display device 20, the infrared light passes through the display panel 21 and is diffusely reflected on a diffuse reflection sheet located at the back side of the display panel 21. The diffuse reflection sheet is located, for example, at a back side of a surface light source. As a result, regardless of the angle of the digital pen 10, part of the infrared light having passed through the display panel 21 returns to the digital pen 10 side. The infrared light that is emitted from the irradiation section 14 and diffusely reflected on the diffuse reflection sheet of the display device 20 is incident on the objective lens 15a. The image sensor 15b is provided on the optical axis of the objective lens 15a. The image sensor 15b converts an optical image formed on an imaging surface thereof to an electrical signal to generate an image signal, and outputs the image signal to the control section 16. The image sensor 15b is composed of, for example, a CCD image sensor or a CMOS image sensor. Although described in detail later, the information patterns 3 (dot patterns) of the marks 31 (dots) are formed from a material that absorbs infrared light (a material having a low transmittance for infrared light). Thus, almost no infrared light returns from the marks 31 of the information patterns 3 to the digital pen 10. On the other hand, a more amount of infrared light returns from the region between each mark 31 than from the region of each mark 31. As a result, an optical image in which the pattern shape of an information pattern 3 is represented in black is captured by the image sensor 15b. In other words, the information pattern 3 is obtained by the image sensor 15b.

As shown in FIG. 2, the control section 16 includes an identification section 16a and a pen-side microcomputer 16b. The identification section 16a identifies position information of the digital pen 10 on the display panel 21 on the basis of an image signal from the obtaining section 15. Specifically, the identification section 16a performs a process of obtaining the pattern shape of an information pattern 3 from an image signal obtained from the obtaining section 15 and identifying position information of the pen tip portion 12 on the display panel 21 on the basis of the pattern shape. The position information regarding the position of the pen tip portion 12 which is identified by the identification section 16a is transmitted to the transmission section 17 via the pen-side microcomputer 16b. The pen-side microcomputer 16b controls the entirety of the digital pen 10. The pen-side microcomputer 16b is composed of a CPU, a memory, and the like and is provided with a program for causing the CPU to operate.

Furthermore, the control section 16 is configured such that authentication result information of the authentication section 150 is supplied thereto. The control section 16 controls operation of the digital pen 10 on the basis of the authentication result information sent from the authentication section 150. Specifically, the control section 16 controls turning-on/off of the digital pen 10. It should be noted that in addition to controlling turning-on/off of the digital pen 10, the control section 16 may control ON/OFF of operation of the irradiation section 14.

The transmission section 17 transmits a signal to an external device. Specifically, the transmission section 17 wirelessly transmits the position information identified by the identification section 16a, to an external device. The transmission section 17 performs short-distance wireless communication with the reception section 22 of the display device 20. The transmission section 17 is provided in an end portion of the body case 11 which is opposite to the pen tip portion 12.

Next, the case where biometric authentication is performed with the digital pen 10 will be described with reference to (b) of FIG. 3. To improve the security of an electronic device, lock with a password or physical lock with a key may be used. However, in authentication with character information such as a password or authentication with a thing such as a key, there is a concern that even the authentic person cannot be authenticated due to forgetting or loss. In addition, as a result of information leak or theft, another person pretends as the authentic person and is authenticated, and there is also a concern that an electronic device may be misused. In contrast, in the case of biometric authentication using biological information as an authentication material, it is considered that the risk of them is low. Biometric authentication is used as authentication means for the purpose of confirming whether the person is the pre-registered authentic person, at entry or exit of electronic control such as at login of a PC or at start of a procedure at an ATM of a bank.

In the present embodiment, by providing the digital pen 10 with a biometric authentication function, it is possible to perform administration or restriction so as to permit only a pre-registered user to use the digital pen 10, and thus it is possible to prevent pretending or spoofing by another person.

As shown in (b) of FIG. 3, when biometric authentication is performed, the user of the digital pen 10 moves their finger close to the irradiation section 14 provided in the digital pen 10. The user puts the finger into an irradiation range of the irradiation section 14. Near-infrared light emitted from the irradiation section 14 is applied to the finger of the user. At that time, reduced hemoglobin in blood flowing in veins within the finger absorbs the applied near-infrared light. An image of the reflected light from the finger is captured by the obtaining section 15 which receives the near-infrared light, and a finger vein pattern of the user is extracted therefrom at the control section 16. Specifically, the reflected light from the finger is incident on the objective lens 15a. The objective lens 15a causes the reflected light from the finger to form an image on the imaging surface of the image sensor 15b. The image sensor 15b converts the optical image formed on the imaging surface to an electrical signal to generate an image signal, and outputs the image signal to the control section 16. The control section 16 performs image processing on the image signal to obtain a finger vein pattern of the user, and records the finger vein pattern as obtained biological information into the first recording section 111 within the recording section 110. In this manner, the finger vein pattern of the user is read by the obtaining section 15 and the control section 16. Here, the control section 16 may be configured to control light emission such that the emission intensity of the near-infrared light emitted from the irradiation section 14, or the like is different between the time of reading the information pattern 3 as shown in (a) of FIG. 3 and the time of reading the biological information as shown in (b) of FIG. 3.

The second recording section 112 has retained a pre-registered finger vein pattern as registered biological information. In the second recording section 112, the user information for identifying the user is linked to the finger vein pattern. For example, when registering user information on the display control system 100, the user causes the digital pen 10 to read their own finger vein pattern.

It should be noted that the first recording section 111 and the second recording section 112 may be provided as the same recording section within the recording section 110.

The collation section 140 collates the finger vein pattern recorded in the first recording section 111 with the pre-registered finger vein pattern recorded in the second recording section 112, and transmits the collation result to the authentication section 150.

The authentication section 150 performs authentication determination in accordance with the collation result from the collation section 140. When the user is identified by the authentication determination, the authentication section 150 outputs to the control section 16 authentication result information that the user has been authenticated. Upon reception of this authentication result information, the control section 16 sets the digital pen 10 such that a pen input is enabled on the display device 20.

[4. Details of Information Patterns]

In FIG. 4, (a) is a diagram showing an arrangement pattern of the marks 31. In (a) and (b) of FIG. 4, for explaining the position of each mark 31, first reference lines 44 and second reference lines 45 are shown as virtual lines (lines that do not actually exist). The first reference lines 44 and the second reference lines 45 are perpendicular to each other. In (a) and (b) of FIG. 4, a grid is formed of a plurality of the first reference lines 44 arranged, for example, at equal intervals and a plurality of the second reference lines 45 arranged, for example, at equal intervals.

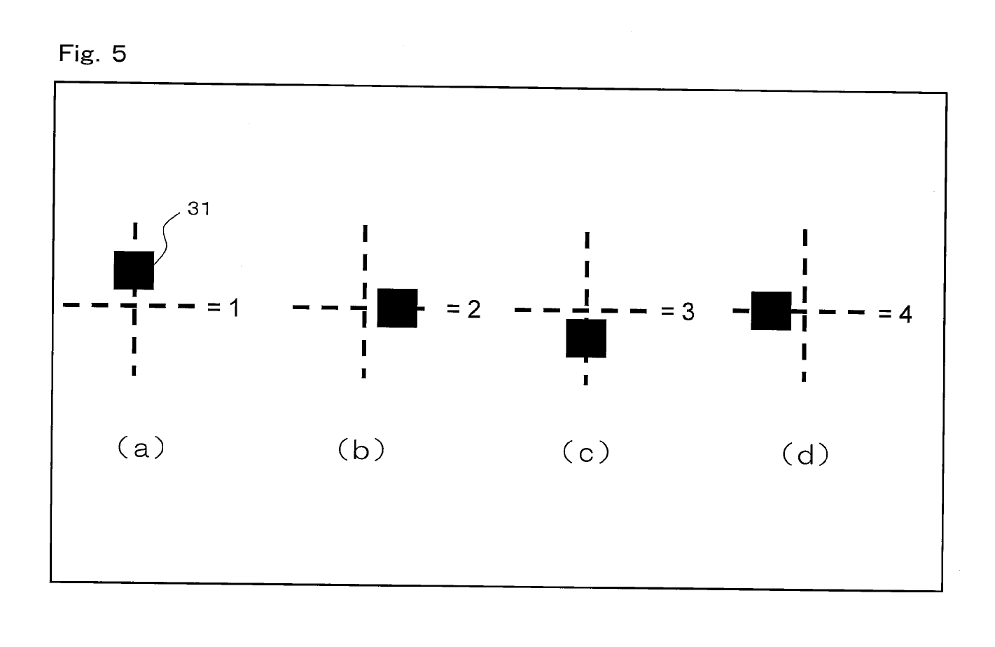

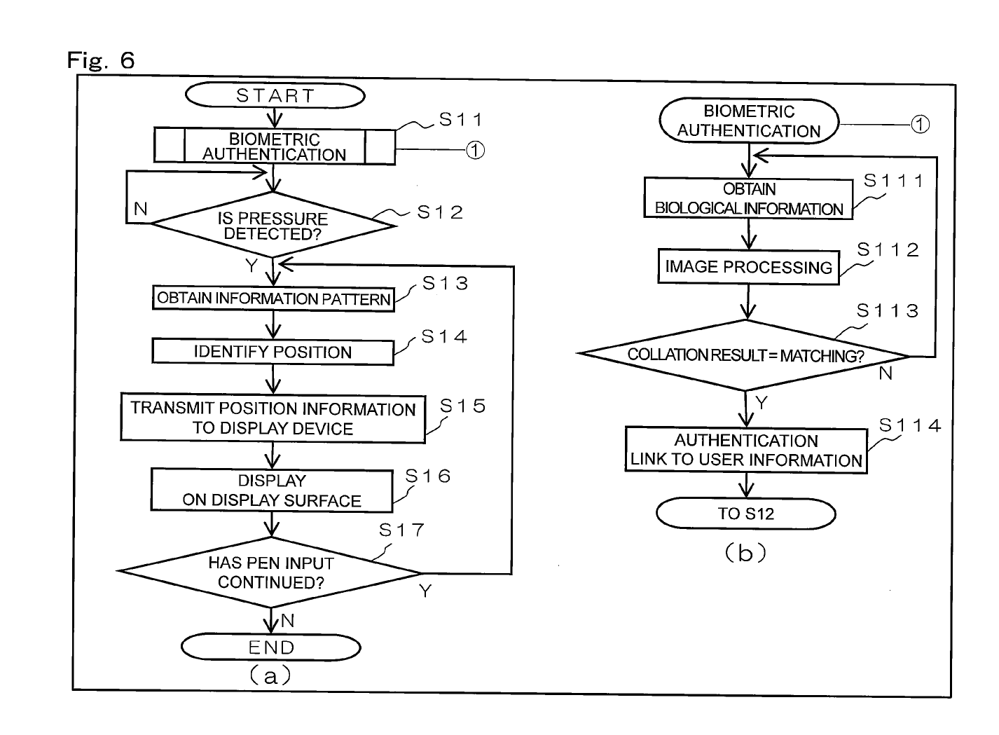

Each mark 31 is arranged at a position that is shifted (offset) from the intersection of the first reference line 44 and the second reference line 45 in any one of four directions that are directions in which the first reference line 45 extends and directions in which the second reference line 45 extends. Specifically, each mark 31 is arranged as shown in any one of (a) to (d) of FIG. 5. In the arrangement of (a) of FIG. 5, the mark 31 is arranged at a position above the intersection of the first reference line 44 and the second reference line 45. This arrangement is represented by “1” when numeric conversion is performed thereon. In the arrangement of (b) of FIG. 5, the mark 31 is arranged at a position on the right side of the intersection of the first reference line 44 and the second reference line 45. This arrangement is represented by “2” when numeric conversion is performed thereon. In the arrangement of (c) of FIG. 5, the mark 31 is arranged at a position below the intersection of the first reference line 44 and the second reference line 45. This arrangement is represented by “3” when numeric conversion is performed thereon. In the arrangement of (d) of FIG. 5, the mark 31 is arranged at a position on the left side of the intersection of the first reference line 44 and the second reference line 45. This arrangement is represented by “4” when numeric conversion is performed thereon. Each mark 31 is converted to numerical information of “1” to “4” in the digital pen 10 in accordance with the arrangement position with respect to the intersection of the first reference line 44 and the second reference line 45.

Then, as shown in (b) of FIG. 4, 6 marks×6 marks are set as one unit area 50, and one information pattern 3 is formed of the 36 marks 31 included in a unit area 50. By arranging each of the 36 marks 31, included in each unit area 50, at any of “1” to “4” shown in FIG. 5, it is possible to form a huge number of information patterns 3 having information different from each other. In the display panel 21, all the information patterns 3 in the respective unit areas 50 are different from each other.

Information is added to each of these information patterns 3. Specifically, each information pattern 3 represents a position coordinate of each unit area 50. In other words, when the optical film of the display panel 21 is divided in the unit areas 50 of 6 marks×6 marks, the information pattern 3 in each unit area 50 represents a position coordinate of the unit area 50. In (b) of FIG. 4, an information pattern 3 in an area 50a represents a position coordinate of the center of the area 50a, and an information pattern 3 in an area 50b represents a position coordinate of the center of the area 50b. When the pen tip moves diagonally downward right in (b) of FIG. 4, an area 50 from which an information pattern 3 is read by the digital pen 10 is changed from the area 50a to the area 50b. As the method for patterning (coding) or coordinate transformation (decoding) of such an information pattern 3, for example, a publicly known method as disclosed in Japanese Laid-Open Patent Publication No. 2006-141061 may be used.

[5. Material of Marks]

Each mark 31 can be formed from a material that transmits visible light (light having a wavelength of 400 to 700 nm) and absorbs infrared light (light having a wavelength of 700 nm or longer). Each mark 31 is formed from, for example, a material that absorbs infrared light having a wavelength of 800 nm or longer. Specifically, each mark 31 is formed from a material having a transmittance of 90% or higher for visible light and a transmittance of 50% or lower (e.g., 20% or lower) for infrared light. For example, each mark 31 may be formed from a material having a transmittance of 10% for infrared light.

Examples of such materials include diimmonium-based compounds, phthalocyanine-based compounds, and cyanine-based compounds. These materials may be used singly or may be mixed and used. A diimmonium salt-based compound is preferably included as a diimmonium-based compound. The diimmonium salt-based compound has a large absorption in the near-infrared range, has a wide range of absorption, and also has a high transmittance for light in the visible light range. As the diimmonium salt-based compound, a commercially available product may be used, and, for example, KAYASORB series (Kayasorb IRG-022, IRG-023, IRG-024, etc.) manufactured by Nippon Kayaku Co., Ltd. and CIR-1080, CIR-1081, CIR-1083, CIR-1085, etc. manufactured by Japan Carlit Co., Ltd. are preferred. As a cyanine-based compound, a commercially available product may be used, and, for example, TZ series (TZ-103, TZ-104, TZ-105, etc.) manufactured by ADEKA Corporation and CY-9, CY-10, etc. manufactured by Nippon Kayaku Co., Ltd. are preferred.

The case has been described above in which each mark 31 absorbs infrared light (has a low transmittance for infrared light). However, each mark 31 may be formed so as to diffusely reflect infrared light. In such a case, infrared light incident from the outside of the display panel 21 is diffusely reflected on each mark 31, and thus part thereof surely reaches the image sensor 15b. The digital pen 10 is allowed to recognize the reflected light from each mark 31. On the other hand, the region between each mark 31 specularly reflects infrared light. From the region between each mark 31, almost no infrared light reaches the image sensor 15b. An optical image in which an information pattern 3 is represented in white is captured by the image sensor 15b.

[6. Operation]

Subsequently, an operation of the display control system 100 configured thus will be described. In FIG. 6, (a) is a flowchart showing flow of a process of the display control system 100. Hereinafter, the case will be described in which the user writes a character on the display device 20 with the digital pen 10. In addition, in FIG. 6, (b) is a flowchart showing flow of a process of biometric authentication.

First, when the display control system 100 is turned on, biometric authentication for the user who uses the digital pen 10 is performed in Step S11. Here, the details of the biometric authentication process in Step S11 will be described with reference to (b) of FIG. 6.

When the display control system 100 is turned on, the irradiation section 14 starts emitting infrared light. When a finger of the user is put into the irradiation range of the irradiation section 14, the near-infrared light emitted from the irradiation section 14 is applied to the finger of the user. In Step S111 in (b) of FIG. 6, the obtaining section 15 generates an image signal from the near-infrared light reflected on the finger of the user and outputs the image signal to the control section 16. It should be noted that image capturing by the obtaining section 15 may be executed by the user pressing a button provided in the digital pen 10, or may be executed by detecting entry of the finger of the user into the irradiation range of the irradiation section 14 with a sensor or the like.

In Step S112, the control section 16 performs image processing on the image signal received from the obtaining section 15 and extracts a finger vein pattern of the user. The extracted finger vein pattern is recorded into the first recording section 111 within the recording section 110. It should be noted that a pre-registered finger vein pattern has been recorded in the second recording section 112.

In Step S113, the collation section 140 collates the finger vein pattern (obtained biological information) recorded in the first recording section 111 with the finger vein pattern (registered biological information) recorded in the second recording section 112. At that time, as a result of the collation by the collation section 140, when it is determined that the obtained biological information does not match with the registered biological information (No in Step S113), the user is not identified, and the processing returns to Step S111. On the other hand, when it is determined that the obtained biological information matches with the registered biological information (by the biometric authentication, the user is confirmed as the authentic person) (Yes in Step S113), the processing proceeds to Step S114, and the authentication section 150 authenticates the user. Then, the control section 16 receives an authentication result from the authentication section 150 and links to the user information associated with the registered biological information that matches with the obtained biological information, and the processing proceeds to Step S12. When the processing proceeds to Step S12, a process of reading an information pattern 3 is started in accordance with a detection result of the pressure sensor 13. As described above, by causing the processing to proceed to Step S12 when the control section 16 receives the authentication result that the user has been authenticated, the control section 16 permits execution of the process of reading an information pattern 3 and controls start of the process of reading an information pattern 3. It should be noted that in the present embodiment, until the user is authenticated, the processing is prevented from proceeding to a process of obtaining an information pattern 3 (Step S13), but it is possible to control whether to start the process of reading an information pattern 3, also by preventing the processing from proceeding to image processing in Step S14 until the user is authenticated.

In addition, when it is determined in Step S113 that the obtained biological information does not match with the registered biological information, the processing may not return to Step S111, and the control section 16 may turn off the digital pen 10 or may turn off the irradiation section 14. In these cases as well, the control section 16 does not permit execution of the process of reading an information pattern 3 and controls start of the process of reading an information pattern 3.

In Step S12, the pen-side microcomputer 16b of the digital pen 10 starts monitoring a pressure applied to the pen tip portion 12. The pressure detection is performed by the pressure sensor 13. When a pressure is detected by the pressure sensor 13 (Yes in Step S12), the pen-side microcomputer 16b determines that the user is performing a pen input of a character on the display panel 21 of the display device 20, and the processing proceeds to step S13. While no pressure is detected by the pressure sensor 13 (while No continues in Step S12), the pen-side microcomputer 16b repeats step S12.

In step S13, the obtaining section 15 of the digital pen 10 obtains an information pattern 3 formed in the display panel 21. Here, the infrared light emitted from the irradiation section 14 is diffusely reflected on the diffuse reflection sheet of the display panel 21 as described above. The diffusely-reflected infrared light is received by the image sensor 15b via the objective lens 15a. The objective lens 15a is arranged so as to receive reflected light from a position, on the display panel 21, which is pointed to by the pen tip portion 12. As a result, an image of the information pattern 3 at the position, on the display surface of the display panel 21, which is pointed to by the pen tip portion 12 is captured by the image sensor 15b. In this manner, the obtaining section 15 optically obtains the information pattern 3. An image signal obtained by the obtaining section 15 is transmitted to the identification section 16a.

In step S14, the identification section 16a obtains the pattern shape of the information pattern 3 from the image signal, and identifies the position of the pen tip portion 12 on the display surface of the display panel 21 on the basis of the pattern shape. Specifically, the identification section 16a obtains the pattern shape of the information pattern 3 by performing determined image processing on the obtained image signal. Subsequently, the identification section 16a determines which unit area 50 (unit area of 6 marks×6 marks) the pointed position is located at, from the arrangement of the marks 31 in the obtained pattern shape. That is, the identification section 16a identifies the position coordinate (position information) of the unit area 50 from the information pattern 3 in the unit area 50. The identification section 16a transforms the information pattern 3 to the position coordinate by determined calculation corresponding to the method for coding of the information pattern 3. The identified position information is transmitted to the pen-side microcomputer 16b.

Subsequently, in step S15, the pen-side microcomputer 16b transmits the position information to the display device 20 via the transmission section 17.

The position information transmitted from the digital pen 10 is received by the reception section 22 of the display device 20. The received position information is transmitted from the reception section 22 to the display-side microcomputer 23. In step S16, upon reception of the position information, the display-side microcomputer 23 controls the display panel 21 so as to change a displayed content at a position, on the display surface of the display panel 21, corresponding to the position information. In this example, because of character input, a spot is displayed at the position, on the display surface of the display panel 21, corresponding to the position information.

Subsequently, in step S17, the pen-side microcomputer 16b determines whether the pen input performed by the user has continued. When the pressure sensor 13 detects a pressure, the pen-side microcomputer 16b determines that the pen input performed by the user has continued, and the processing returns to step S13. Then, by repeating a flow of steps S13 to S17, spots are continuously displayed at the position of the pen tip portion 12 on the display surface of the display panel 21 so as to follow movement of the pen tip portion 12 of the digital pen 10. At the end, a character corresponding to the trajectory of the pen tip portion 12 of the digital pen 10 is displayed on the display panel 21 of the display device 20.

On the other hand, in step S17, when the pressure sensor 13 detects no pressure, the pen-side microcomputer 16b determines that the pen input performed by the user has not continued, and the process is ended.

As described above, the display device 20 displays, on the display panel 21, the trajectory of the tip of the digital pen 10 on the display surface of the display panel 21. By so doing, it is possible to perform a handwriting input on the display panel 21 with the digital pen 10.

It should be noted that the case has been described above in which a character is written, but the use of the display control system 100 is not limited thereto. Needless to say, other than characters (numbers etc.), it is possible to write symbols, figures, and the like. In addition, it is also possible to delete a character, a figure, or the like displayed on the display panel 21 by using the digital pen 10 like an eraser. In other words, the display device 20 continuously deletes a display image at the position of the tip of the digital pen 10 on the display panel 21 so as to follow movement of the tip of the digital pen 10, whereby it is possible to delete the display image at the portion corresponding to the trajectory of the tip of the digital pen 10 on the display panel 21. Furthermore, it is also possible to move a cursor displayed on the display panel 21 or select an icon displayed on the display panel 21, by using the digital pen 10 like a mouse. In other words, it is possible to operate a graphical user interface (GUI) by using the digital pen 10. As described above, in the display control system 100, an input to the display device 20 is performed in accordance with a position, on the display panel 21, which is pointed to by the digital pen 10, and the display device 20 performs various display control in accordance with the input.

[7. Advantageous Effects Etc.]

In the present embodiment, in the obtaining section 15, the same component (the image sensor 15b) is used for obtaining an information pattern 3 and for obtaining biological information of the user. Thus, it is possible to reduce the number of components in the digital pen 10 that is capable of biometric authentication.

In addition, in the present embodiment, in the irradiation section 14, the light source (infrared light LED) that emits light when an information pattern 3 is obtained and the light source that emits light when biological information of the user is obtained are the same. In other words, the light source for obtaining an information pattern 3 also serves as a light source for obtaining biological information. In the present embodiment, the same light source is used with a focus on the fact that the infrared light used for obtaining an information pattern 3 can also be used for obtaining a vein pattern of a finger or the like. Thus, it is possible to further reduce the number of components.

(Modifications)

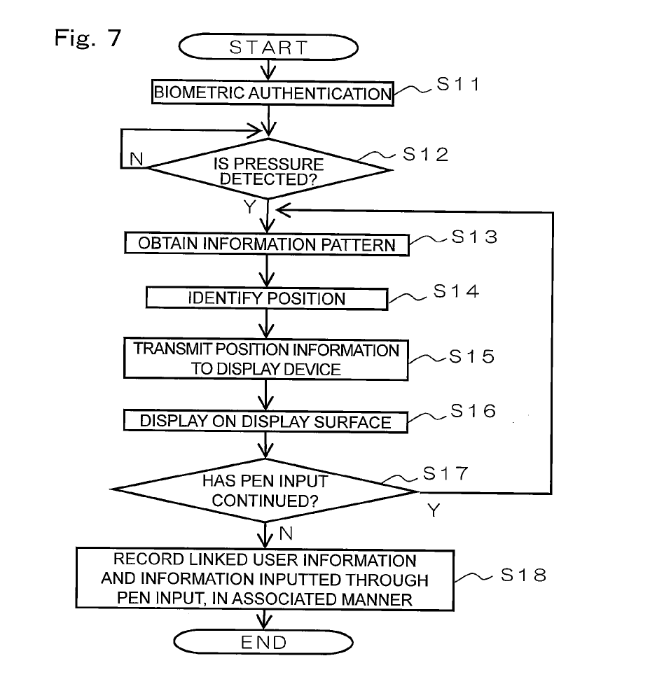

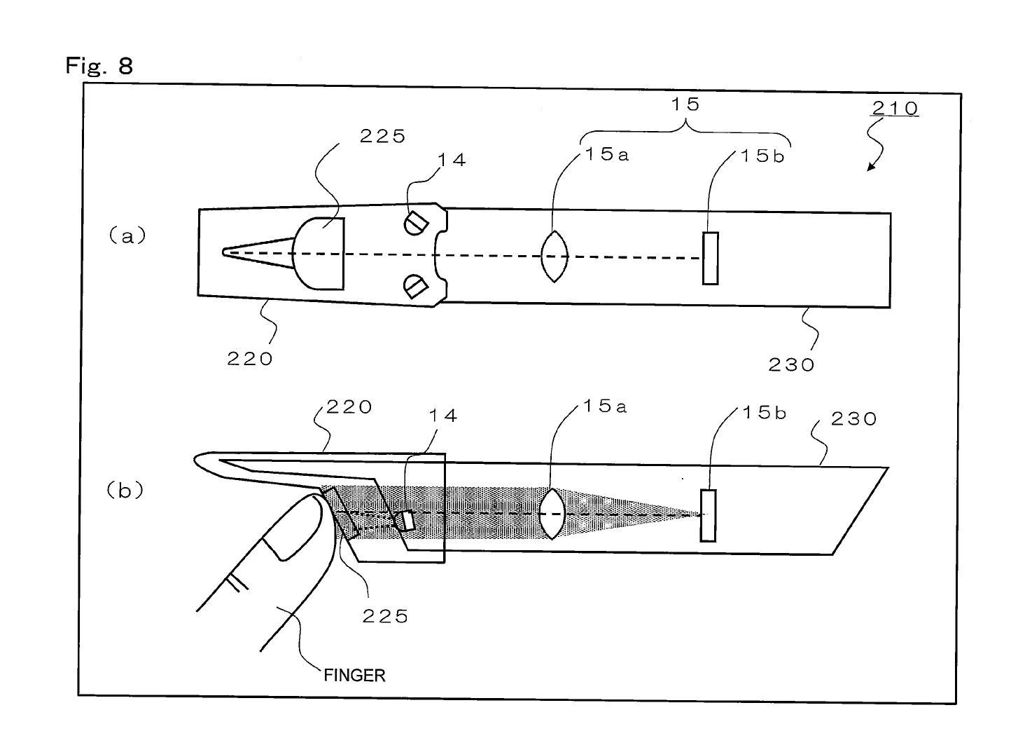

FIG. 7 is a flowchart for explaining flow of a process regarding a modification of the digital pen 10. The flowchart shown in FIG. 7 is different from the flowchart shown in FIG. 6, in that information inputted through a pen input by the user with the digital pen 10 is recorded so as to be associated with the user information (the user information linked in Step S114 in Step S11) (Step S18).

For example, in the case where the digital pen 10 is used with respect to the same display device 20 at a meeting by a plurality of people in a shared manner, it is necessary to leave a user history about who has written which.

Or, even in the case where a plurality of digital pens 10 are used with respect to the same display device 20 at a meeting by a plurality of people at the same time, it is necessary to leave a user history about who has written which.

Furthermore, in the case of a public institution such as a city office or the like, etc., for example, in the case where the digital pen 10 is privately owned and used, it is necessary to allow only a pre-registered person to use the digital pen 10. In the modification of the present embodiment, after biometric authentication is performed in Step S11, information inputted through a pen input is recorded so as to be associated with the linked user information in Step S18, whereby it is possible to associate the user information with a user usage history. Thus, it is made possible to easily administer minutes and the like. In addition, since it is possible to allow only the pre-registered user to use the digital pen 10, even when the user signs an official document, the user feels less stressed, and it is possible to realize easy and advanced security.

It should be noted that when a finger vein pattern is obtained, a range in which the finger vein pattern is obtained may be expanded by scanning the finger while the finger being moved.

Moreover, in the present embodiment, the use of the display device 20 is assumed, but a pen that is used for writing on a paper surface on which information patterns have been printed may perform biometric authentication. In the case of writing on the paper surface, it is only necessary to change the pen tip portion 12 of the digital pen 10 according to the above embodiment to a pen tip portion from which ink or the like is discharged.

### Embodiment 2

Next, a digital pen 210 according to Embodiment 2 will be described. The digital pen 210 is different from the digital pen 10 according to Embodiment 1, in including a cap 220. Hereinafter, the difference from Embodiment 1 will be mainly described.

FIG. 8 is a schematic cross-sectional view showing the digital pen 210, (a) of FIG. 8 is a horizontal cross-sectional view of the digital pen 210 in which the pen tip portion 12 is located at the upper side as shown in (b) of FIG. 8, and (b) of FIG. 8 is a vertical cross-sectional view of the digital pen 210.

As shown in (a) and (b) of FIG. 8, the digital pen 210 includes a pen body 230 and the cap 220 that covers a pen tip of the pen body 230. The cap 220 is detachable from the pen body 230.

The cap 220 includes a conversion lens 225 in the irradiation range of the irradiation section 14 in a state where the cap 220 is mounted on the pen body 230. The conversion lens 225 is a lens capable of transmitting infrared light reflected on a finger of the user.

When biometric authentication is performed, the user brings their finger into contact with the conversion lens 225, whereby the infrared light from the irradiation section 14 is applied to the finger through the conversion lens 225. The infrared light reflected on the finger passes through the conversion lens 225 and the objective lens 15a and is caused to form an image on the image sensor 15b. By so doing, it is possible to obtain an image of a finger vein pattern of the user.

The use of the cap 220 including the conversion lens 225 allows for changing the focal length of the emitted light of the irradiation section 14 and obtaining a finger vein pattern of the user. Thus, it is possible to perform biometric authentication in a state where the pen tip is covered with the cap 220, and hence the pen tip is unlikely to hurt the fingers of the user. In addition, by changing the optical characteristic of the conversion lens 225, when a finger vein pattern of the user is obtained, it is possible to change a range where the finger vein pattern is obtained.

### Embodiment 3

Next, a digital pen 310 according to Embodiment 3 will be described. The digital pen 310 is different from the above Embodiment 2, in that a cap 320 includes a mirror 325 and a pen body 330 includes a flap 335. Hereinafter, the difference from Embodiment 2 will be mainly described.

FIG. 9 is a schematic cross-sectional view showing the digital pen 310. In FIG. 9, (a) is a cross-sectional view showing a state where vein authentication for the user is not performed, and (b) is a cross-sectional view showing a state where vein authentication for the user is performed.

As shown in (a) and (b) of FIG. 9, the digital pen 310 includes the pen body 330 and the cap 320.

The cap 320 includes the mirror 325 at a position facing the irradiation section 14. The mirror 325 is located inside the cap 320 and in the irradiation range of the irradiation section 14 in a state where the cap 320 is mounted on the pen body 330. The mirror 325 reflects the light emitted from the irradiation section 14, in the direction toward the image sensor 15b.

The pen body 330 includes the flap 335 at a side surface of the pen body 330 (a tubular body portion). The flap 335 is configured to open in the inward direction of the pen body 330. As shown in (a) of FIG. 9, in a state before biometric authentication and when a pen input is performed with the digital pen 310, the flap 335 is closed. In addition, a space for authentication into which a fingertip of the user is allowed to enter is formed at the inner side of the flap 335 in the internal space of the pen body 330. Infrared light that is reflected on the mirror 325 and travels toward the image sensor 15b passes through the space for authentication. As shown in (b) of FIG. 9, when biometric authentication is performed, the user presses the flap 335 with their finger. The flap 335 is opened to the inside of the pen body 330 by being pressed with the finger. At that time, the finger of the user also enters into the pen body 330, and the fingertip of the user is located in the space for authentication. In this state, infrared light is emitted from the irradiation section 14. The emitted light is reflected on the mirror 325. The reflected light passes through the finger of the user since the reflected light is infrared light. An image of the light having passed through the finger of the user is captured by the image sensor 15b. In this manner, an image of a finger vein pattern of the user is captured.

In the present embodiment, it is possible to perform biometric authentication at the side surface portion of the pen body 330, namely, at a portion where the user holds the digital pen 10. In Embodiments 1 and 2, it is necessary to put a finger on the pen tip, but in the present embodiment, it is possible to perform biometric authentication in a state where the digital pen 310 is kept held. Thus, it is possible to smoothly perform biometric authentication.

### Embodiment 4

Next, a biometric authentication system according to Embodiment 4 will be described. The present embodiment is different from the above-described embodiments in the collation process, the authentication process, and management of information which are performed in the digital pens 10, 210, and 310 are performed in a server 420. Hereinafter, the difference in configuration will be mainly described.

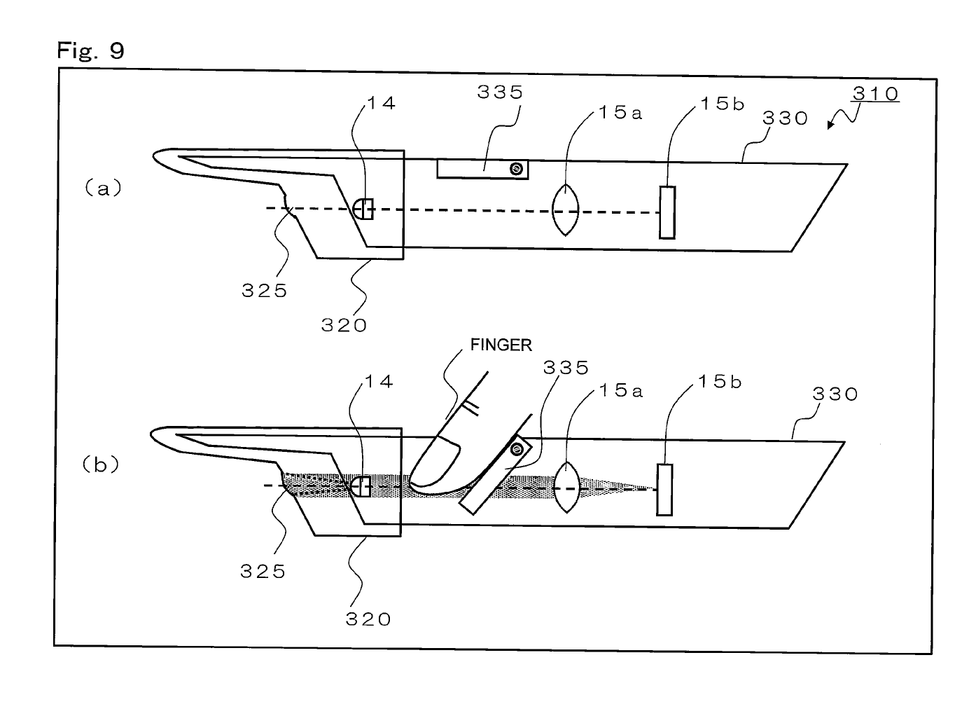

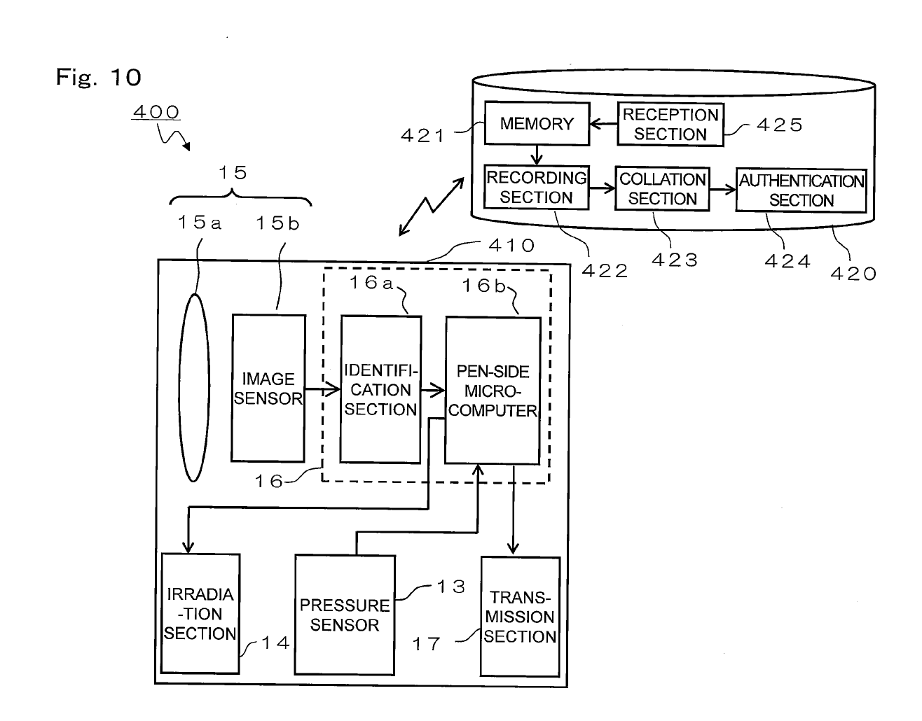

FIG. 10 is a schematic cross-sectional view showing a biometric authentication system 400. The biometric authentication system 400 includes a digital pen 410 and the server 420.

The digital pen 410 does not include a recording section that has previously recorded therein registered biological information of a user and user information for identifying the user. The digital pen 410 transmits obtained biological information which is obtained through image capturing for biometric authentication, to the server 420 via the transmission section 17 (an example of a first communication section). It should be noted that a wireless LAN, Wi-Fi, or the like may be used as communication means.

The server 420 includes a reception section 425 (an example of a second communication section) that receives information transmitted from the transmission section 17; a memory 421 that temporarily records transmitted obtained biological information; a recording section 422 that has previously recorded therein registered biological information of the user of the digital pen 410 and user information for identifying the user; a collation section 423; and an authentication section 424.

In the server 420, the collation section 423 performs a process of collating obtained biological information transmitted from the digital pen 410 with the registered biological information recorded in the recording section 422, and the authentication section 424 performs an authentication process on the basis of the collation result of the collation section 423. The server 420 transmits authentication result information to the digital pen 410. When the user has been authenticated, the digital pen 410 is made usable by the control section 16 of the digital pen 410 permitting a process of reading an information pattern 3.

In the present embodiment, since the recording section 422, the collation section 423, and the authentication section 424 are provided in the server 420, it is possible to reduce the processing load on the digital pen 410. In addition, it is possible to eliminate a restriction on the number of users to be registered (the number of pieces of registered biological information), and when each of a plurality of users has previously registered their biological information on the server 420, each of the plurality of users is allowed to fill out an application or sign etc. with the shared digital pen 410. Therefore, since only each of the pre-registered users is allowed to use the digital pen 410, even when the user signs an official document, the user feels less stressed, and it is possible to realize easy and advanced security.

### Other Embodiments

As described above, Embodiments 1 to 4 have been described as an illustrative example of the technology disclosed in the present application. However, the technology in the present disclosure is not limited thereto, and is also applicable to embodiments in which changes, substitutions, additions, omissions, and/or the like are made as appropriate. In addition, each constituent element described in the above Embodiments 1 to 4 can be combined to provide a new embodiment.

Other embodiments will be described below.

The above embodiments have been described with the liquid crystal display as an example of the display device, but the display device is not limited thereto. The display device 20 may be a device capable of displaying characters or video, such as a plasma display, an organic EL display, or an inorganic EL display. In addition, the display device 20 may be a device whose display surface is freely deformed, such as electronic paper.

In addition, the display device 20 may be a display of a notebook PC or a portable tablet. Furthermore, the display device 20 may be a television, an electronic whiteboard, or the like.

In the above embodiments, the optical film on which the information patterns 3 are formed is arranged on a color filter, but the present disclosure is not limited thereto. The marks 31 may be formed directly on the color filter.

The digital pen 10 or the display device 20 may include a switching section that switches a process to be performed in accordance with an input of position information from the digital pen 10. Specifically, a switch may be provided in the digital pen 10 and may be configured to be switchable among input of characters or the like, deletion of characters or the like, movement of a cursor, selection of an icon, and the like. In addition, icons for switching among input of characters or the like, deletion of characters or the like, movement of a cursor, selection of an icon, and the like may be displayed on the display device 20 and may be selectable by using the digital pen 10. Furthermore, switches corresponding to a right click and a left click of a mouse may be provided in the digital pen 10 or the display device 20. By so doing, it is possible to further improve the operability of the GUI.

The configurations of the digital pen 10 and the display device 20 are examples, and the present disclosure is not limited thereto.

In the above embodiments, transmission and reception of signals between the digital pen 10 and the display device 20 are performed by means of wireless communication, but the present disclosure is not limited thereto. The digital pen 10 and the display device 20 may be connected to each other via a wire, and transmission and reception of signals therebetween may be performed via the wire.

The identification section that identifies the position of the digital pen 10 on the display panel 21 may be provided as a control device independent of the digital pen 10 and the display device 20. For example, in a display control system in which a digital pen is added to a desktop PC including a display (an example of a display device) and a PC body (an example of a control device), information patterns 3 may be formed in a display panel of the display. The digital pen may optically obtain an information pattern 3 and may transmit an image signal to the PC body. Then, the PC body may identify the position of the digital pen from the image signal of the information pattern 3 and may instruct the display to perform a process corresponding to the identified position.

In the above embodiments, the pressure sensor 13 is used only for determining whether a pressure is applied, but the present disclosure is not limited thereto. For example, the magnitude of a pressure may be detected on the basis of a detection result of the pressure sensor 13. By so doing, it is possible to read continuous change in the pressure. As a result, on the basis of the magnitude of the pressure, it is possible to change the thickness or the color density of a line to be displayed through a pen input.

In the above embodiments, presence/absence of an input with the digital pen 10 is detected with the pressure sensor 13, but the present disclosure is not limited thereto. A switch that switches between ON and OFF of a pen input may be provided in the digital pen 10, and when the switch is turned ON, it may be determined that a pen input is present. In such a case, even when the digital pen 10 is not in contact with the surface of the display panel 21, it is possible to perform a pen input. Alternatively, the display device 20 may vibrate the display surface of the display panel 21 at a determined vibration frequency. In such a case, the display device 20 is configured to detect presence/absence of a pen input by detecting change in the vibration frequency which is caused by contact of the digital pen 10 with the display surface of the display panel 21.

In the above embodiments, each mark 31 is arranged at a position that is shifted from the intersection of the first reference line 44 and the second reference line 45 in a direction along the first reference line 44 or the second reference line 45. However, each mark 31 may be arranged at a position that is shifted from the intersection of the first reference line 44 and the second reference line 45 in an oblique direction with respect to the first reference line 44 and the second reference line 45.

The arrangement pattern of each mark 31 is not limited thereto. Any method may be used for coding of an information pattern 3, and thus the arrangement pattern of each mark 31 may be changed in accordance with the used coding method.

The first reference lines 44 and the second reference lines 45 for arranging the marks 31 are not limited to those in the above embodiments. For example, the first reference lines 44 may be defined on a black matrix or may be defined on a pixel region (sub-pixel). Furthermore, it is possible to arbitrarily select what color of pixel regions the first reference lines 44 are defined on. The same applies to the second reference lines 45.

In the above embodiments, each information pattern 3 is formed in the unit area 50 of 6 marks×6 marks, but is not limited thereto. The number of the marks 31 constituting the unit area 50 may be set as appropriate in accordance with the designs of the digital pen 10 and the display device 20. In addition, the configuration of each information pattern 3 is not limited to the combination of the arrangements of the marks 31 included in a determined area. The coding method is not limited to that in the above embodiments as long as each information pattern 3 is able to represent specific position information.

In the above embodiments, each information pattern 3 is composed of rectangular marks, but is not limited thereto. Each information pattern 3 may be composed of a plurality of marks represented by figures such as triangles or characters such as alphabets, instead of the rectangular marks. For example, each mark 31 may be formed over the entirety of a pixel region (sub-pixel).

The identification section 16a transforms an information pattern 3 to a position coordinate by calculation, but the present disclosure is not limited thereto. For example, the identification section 16a may previously store all information patterns 3 and position coordinates linked to the respective information patterns 3 and may identify a position coordinate by checking an obtained information pattern 3 against the relationships between the stored information patterns 3 and position coordinates.

As presented above, the embodiments have been described as an example of the technology according to the present disclosure. For this purpose, the accompanying drawings and the detailed description are provided.

Therefore, components in the accompanying drawings and the detail description may include not only components essential for solving problems, but also components that are provided to illustrate the above described technology and are not essential for solving problems. Therefore, such inessential components should not be readily construed as being essential based on the fact that such inessential components are shown in the accompanying drawings or mentioned in the detailed description.

Further, the above described embodiments have been described to exemplify the technology according to the present disclosure, and therefore, various modifications, replacements, additions, and omissions may be made within the scope of the claims and the scope of the equivalents thereof.

What is claimed is:

1. An information obtaining device which obtains an information pattern formed in a display panel or on a paper surface, the information obtaining device comprising:
an obtaining section configured to obtain the information pattern and biological information of a user;
a collation section configured to collate the biological information of the user obtained by the obtaining section with pre-registered biological information;
an authentication section configured to authenticate the user on the basis of a collation result of the collation section; and
a control section configured to control whether to start a process of reading the information pattern, on the basis of an authentication result of the authentication section, the process including a process of obtaining the information pattern by the obtaining section.

2. The information obtaining device according to claim 1, wherein
the obtaining section includes an image sensor configured to receive incident light, and
an image sensor configured to obtain the information pattern and an image sensor configured to obtain the biological information of the user are the same image sensor.

3. The information obtaining device according to claim 1, further comprising an irradiation section configured to emit light, wherein
the obtaining section obtains the information pattern or the biological information of the user from reflected light of the light emitted from the irradiation section, and
in the irradiation section, a light source configured to emit light when the information pattern is obtained and a light source configured to emit light when the biological information of the user is obtained are the same.

4. The information obtaining device according to claim 1, further comprising an irradiation section configured to emit light, wherein
the obtaining section obtains the information pattern or the biological information of the user from reflected light of the light emitted from the irradiation section, and
the control section controls light emission of the irradiation section such that an emission condition of the irradiation section is different between when the information pattern is obtained and when the biological information is obtained.

5. A display control system including a display panel in which an information pattern is formed and an information obtaining device which obtains the information pattern, the display control system controlling display of the display panel on the basis of the information pattern obtained by the information obtaining device, wherein
the information obtaining device includes:
an obtaining section configured to obtain the information pattern and biological information of a user;
a collation section configured to collate the biological information of the user obtained by the obtaining section with pre-registered biological information;
an authentication section configured to authenticate the user on the basis of a collation result of the collation section; and
a control section configured to control whether to start a process of reading the information pattern, on the basis of an authentication result of the authentication section, the process including a process of obtaining the information pattern by the obtaining section.

6. A biometric authentication system including a server and an information obtaining device which obtains an information pattern formed in a display panel or on a paper surface, wherein
the information obtaining device includes:
an obtaining section configured to obtain the information pattern and biological information of a user; and
a first communication section configured to transmit the biological information of the user obtained by the obtaining section to the server,
the server includes:
a second communication section configured to receive the biological information of the user from the first communication section;
a collation section configured to collate the biological information of the user received by the second communication section with pre-registered biological information; and
an authentication section configured to authenticate the user on the basis of a collation result of the collation section,
the second communication section transmits an authentication result of the authentication section to the first communication section, and
the information obtaining device includes a control section configured to control whether to start a process of reading the information pattern, on the basis of the authentication result received by the first communication section, the process including a process of obtaining the information pattern by the obtaining section.
